(19) United States
(12) Patent Application Publication
(10) Pub. No.: US 2026/0143302 A1
(43) Pub. Date: May 21, 2026

(54) ESTIMATING DISTANCE BETWEEN WIRELESS DEVICES USING CHANNEL FREQUENCY RESPONSE

(71) Applicant: Silicon Laboratories Inc., Austin, TX (US)

(72) Inventors: Kiruba Sankaran Subramani, Austin, TX (US); Yan Zhou, Spicewood, TX (US); Terry Dickey, Pflugerville, TX (US)

(21) Appl. No.: 18/954,646

(22) Filed: Nov. 21, 2024

(51) Int. Cl. H04W 4/02; H04L 1/00; H04L 5/00

(52) U.S. Cl. CPC H04W 4/023; H04L 1/0042; H04L 5/0007

(57) ABSTRACT

In one aspect, a method includes: receiving, in a first wireless device, a data transmission that includes at least one orthogonal frequency division multiplexing (OFDM) packet from a second wireless device; processing the at least one OFDM packet to recover data and provide the data to a host processor of the first wireless device; encoding, in the first wireless device, at least one decoded symbol of the at least one OFDM packet with forward error correction coding; processing the encoded at least one decoded symbol to recover at least one corresponding transmitted symbol of the at least one OFDM packet; and determining a distance estimate between the first wireless device and the second wireless device based at least in part on the corresponding transmitted symbol.

### BACKGROUND

As wireless and connected devices become ubiquitous, accurate distance measurements may be used for various activities, including several Wi-Fi distance measurement and direction finding use cases. Numerous Time-of-Flight (ToF) based distance measurement techniques have been proposed for Wi-Fi, both from academia and industry. However, these techniques either do not meet desired accuracies and/or are not scalable to large networks. Moreover, the existing techniques require the devices to operate in a specific ranging procedure, such as transmitting packets without payloads, that is not conducive for data transmission. Thus conventional distance estimation techniques are unsatisfactory in at least certain situations.

### SUMMARY OF THE INVENTION

In one aspect, a method includes: receiving, in a first wireless device, a data transmission from a second wireless device, the data transmission comprising at least one orthogonal frequency division multiplexing (OFDM) packet; processing, in the first wireless device, the at least one OFDM packet to recover data and provide the data to a host processor of the first wireless device; encoding, in the first wireless device, at least one decoded symbol of the at least one OFDM packet with forward error correction (FEC) coding; processing the encoded at least one decoded symbol to recover at least one corresponding transmitted symbol (S′(f)) of the at least one OFDM packet; and determining a distance estimate between the first wireless device and the second wireless device based at least in part on the corresponding transmitted symbol (S′(f)).

In an implementation, processing the at least one OFDM packet to recover the data comprises transforming the at least one OFDM packet comprising a time domain signal into a plurality of recovered symbols (R(f)), each of the plurality of recovered symbols (R(f)) comprising a plurality of sub-carriers, the plurality of recovered symbols (R(f)) comprising a channel response. Determining the distance estimate may include: comparing corresponding symbols of S′(f) and R(f); and determining the distance estimate based at least in part on the comparing.

In an implementation, the method further comprises: determining at least one metric of a channel between the first wireless device and the second wireless device; and determining a number of the corresponding symbols of S′(f) and R(f) to compare based at least in part on the at least one metric. The method may also include: receiving feedback information regarding an error detection operation on the at least one OFDM packet; and based at least in part on the feedback information, determining a number of the corresponding symbols of S′(f) and R(f) to compare.

In an implementation, the method further includes determining the distance estimate using amplitude and phase information of a channel between the first wireless device and the second wireless device. The method may also include determining the distance estimate using the at least one OFDM packet, the at least one OFDM packet not including a priori information. The method also may include encoding, in a transmitter of the first wireless device, the at least one decoded symbol of the at least one OFDM packet with the FEC coding.

In an implementation, the method further comprises: after determining the distance estimate between the first wireless device and the second wireless device, communicating distance information to the second wireless device based at least in part on the distance estimate, to enable the second wireless device to control transmit power using the distance information, the second wireless device unconfigured to determine the distance estimate. The method also may include: receiving, in the first wireless device, the data transmission comprising a plurality of OFDM packets; determining a channel frequency response of a channel between the first wireless device and the second wireless using at least some symbols of the plurality of OFDM packets; and determining the distance estimate between the first wireless device and the second wireless device based on the channel frequency response.

In another aspect, an apparatus includes: a radio frequency (RF) front end circuit to receive and process an incoming Wi-Fi RF signal, and to output a baseband signal; and a baseband processor coupled to the RF front end circuit. The baseband processor may include: a receiver signal processing path to receive the baseband signal and process the baseband signal to obtain a data packet therefrom; first circuitry to use the data packet to measure a channel frequency response of a channel between the apparatus and a second device that transmitted the incoming Wi-Fi RF signal based on a one-way communication of the incoming Wi-Fi RF signal from the second device to the apparatus, the channel frequency response comprising amplitude and phase information of the channel; and second circuitry to determine a distance between the apparatus and the second device based at least in part on the channel frequency response.

In one implementation, the apparatus further includes encoder circuitry to receive at least one decoded symbol of the data packet, encode the at least one decoded symbol, and generate, based on the encoded at least one decoded symbol, a representation of at least one transmitted symbol included in the incoming Wi-Fi RF signal, the at least one transmitted symbol corresponding to the at least one decoded symbol. The first circuitry may be configured to measure the channel frequency response based at least in part on the representation of the at least one transmitted symbol and at least one received symbol of the at least one data packet corresponding to the representation of the at least one transmitted symbol.

In one implementation, the apparatus may be a multi-protocol transceiver comprising a receiver and a transmitter, the transmitter comprising the encoder circuitry. The apparatus also may include an integrity detection circuit to determine an integrity of the at least one data packet and provide feedback information based on the integrity to the second circuitry. The second circuitry may be configured to determine a number of the at least one data packet to use to measure the channel response based at least in part on the feedback information. The second circuitry may be configured determine an average of a plurality of channel responses, each of the plurality of channel responses associated with a data packet, and determine the distance based at least in part on the average.

In yet another aspect, a system includes: a transceiver to transmit and receive RF signals of at least one wireless protocol; and a baseband processor coupled to the transceiver. The baseband processor may include: a receiver signal processing path to receive a baseband signal of the at least one wireless protocol and process the baseband signal to obtain a data packet therefrom; an encoder coupled to the receiver signal processing path, the encoder to receive at least one decoded symbol of the data packet, encode the at least one decoded symbol, and generate, based on the encoded at least one decoded symbol, a representation of at least one transmitted symbol corresponding to the at least one decoded symbol; and a distance estimation circuit to estimate a distance between the system and a second system based at least in part on the representation of the at least one transmitted symbol and at least one received symbol of the data packet corresponding to the representation of the at least one transmitted symbol.

In an implementation, the distance estimation circuit is to measure a channel frequency response of a channel between the system and the second system based on a comparison of the representation of the at least one transmitted symbol to the at least one received symbol of the data packet corresponding to the representation of the at least one transmitted symbol. The distance estimation circuit may be configured to estimate the distance based on the channel frequency response.

### BRIEF DESCRIPTION OF THE DRAWINGS

FIG. 1 is a block diagram of a pair of wireless devices in a wireless local area network in accordance with an embodiment.

FIG. 2 is a flow diagram of a method in accordance with an embodiment.

FIG. 3 is a flow diagram of a method in accordance with another embodiment.

FIG. 4 is a timing diagram illustrating a wireless ranging process in accordance with an embodiment.

FIG. 5 is a block diagram of a network environment in accordance with an embodiment.

FIG. 6 is a flow diagram of a method in accordance with another embodiment.

FIG. 7 is a block diagram of a network environment in accordance with another embodiment.

FIG. 8 is a flow diagram of a method in accordance with yet another embodiment.

FIG. 9 is a block diagram of a representative integrated circuit in accordance with an embodiment.

FIG. 10 is a high level diagram of a network in accordance with an embodiment.

### DETAILED DESCRIPTION

In various embodiments, a channel frequency response-based distance measurement technique is provided for use in various wireless schemes, including Wi-Fi wireless communications in accordance with a given IEEE 802.11 specification. Embodiments may operate to measure the channel response across an entire bandwidth on a per orthogonal frequency division multiplexing (OFDM) symbol basis, without any modification of a given wireless standard. Embodiments may achieve sub-meter distance accuracy, and can be used to handle hundreds of devices in a network, while satisfying network throughput.

To effect distance estimation as described herein, embodiments may process an incoming received signal to re-encode it with error correction coding, e.g., forward error coding (FEC) encoding. The resulting received and encoded signal is provided to distance estimation circuitry (which can be implemented as a dedicated circuit, or processing circuitry that executes a distance estimation algorithm or application, which may be implemented as firmware and/or software), along with the received signal, to perform the distance estimation.

Per IEEE 802.11 specifications, an OFDM frame includes a PHY preamble and a signal field followed by data field sub-divided into a plurality of OFDM symbols. The PHY preamble is formed of 10 repetitions of a Short Training Sequence (STS) and 2 repetitions of a Long Training Sequence (LTS). Conventional distance measurement techniques use the LTS for estimating the channel frequency response. However, these techniques only use phase variation to estimate ToF and thereby the distance, and thus are more error prone when operating under multipath conditions. Also, using LTS forecloses scalability to large networks, since the measurement is only performed once per OFDM frame. By measuring channel frequency response on a per symbol basis, hundreds of distance measurements can be performed per second, thereby enabling use in large wireless networks having greater than 100 devices.

Embodiments leverage the error correction capability of OFDM PHY to estimate the channel frequency response on a per OFDM symbol basis, without a priori knowledge of the transmitted data. Such distance estimation may be performed alongside processing of any normal Wi-Fi communication. In addition, embodiments can provide accurate distance measurements even when operating in multipath conditions since both amplitude and phase characteristics of the channel are used. Still further, embodiments may be used in large networks with hundreds of devices, since the channel frequency response is estimated based on a selected number of OFDM symbol basis, rather than just using the LTS.

Frequency response of a multipath channel can be modeled as shown in Equation 1, where ‘Nₚ’ denotes the number of signal paths, ‘αᵢ’ and ‘τᵢ’ denote the gain and delay of each of the signal path, respectively, ‘Δf’ denotes the subcarrier spacing and ‘N_{SC}’ denotes the subcarrier index.

$$H ( f ) = {\sum }_{i = 1}^{{N}_{p}} {α}_{i} {e}^{- j 2 π ( {f}_{c} + ( Δ f * {N}_{S C} ) ) {τ}_{i}} \qquad ( 1 )$$

Transmitted and received baseband signals ‘S(f)’ and ‘R(f)’ can be modeled as shown in Equation 2 and Equation 3 respectively, where ‘Xₖ’ denotes the baseband IQ data that gets mapped onto the subcarrier within each OFDM symbol and ‘W’ represents the complex additive white Gaussian noise (AWGN) in the system.

$$S ( f ) = {\sum }_{k = 0}^{{N}_{S C}} {X}_{k} {e}^{j 2 π ( k * Δ f )} \qquad ( 2 )$$

$$R ( f ) = H ( f ) S ( f ) + W \qquad ( 3 )$$

To estimate the channel's amplitude and phase characteristics from the received signal, one often assumes that the receiver is aware of the signal ‘S(f)’, which is true when leveraging the training sequence such as the LTS. But in the absence of such sequence, embodiments leverage the error correction capability of the receiver to estimate the channel characteristics without a priori knowledge of the transmitted signal ‘S(f)’.

In an embodiment, the IEEE 802.11 specification identifies a rate 1/2 convolutional encoder with a constraint length of 6 and generator polynomials g₀=1011011 and g₁=1111001, respectively in the OFDM PHY. In other embodiments, other convolutional codes can be used for encoding as described herein.

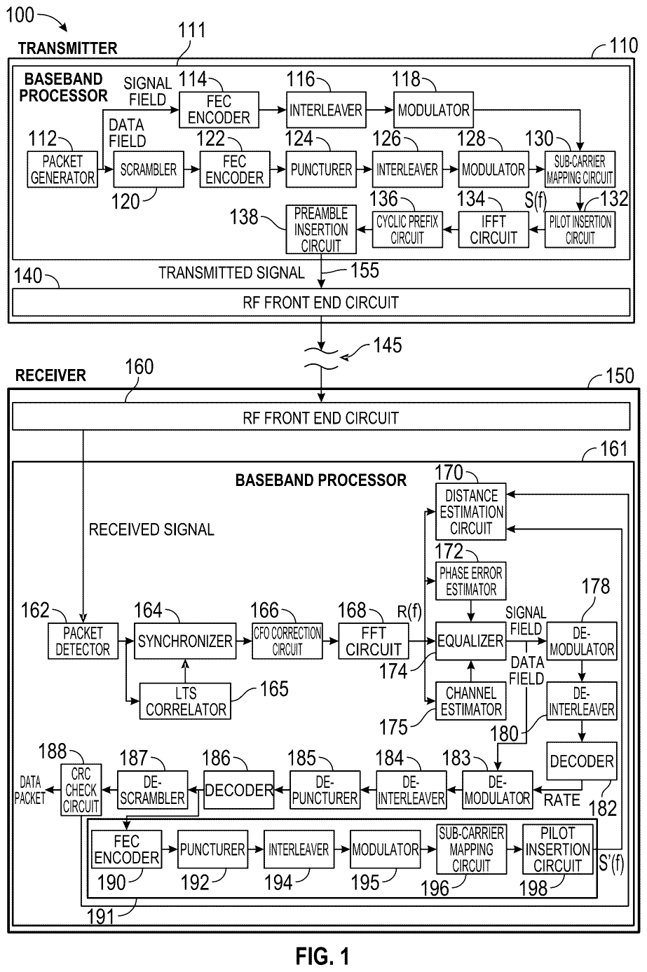

Referring now to FIG. 1, shown is a block diagram of a pair of wireless devices in a wireless local area network (WLAN) in accordance with an embodiment. As shown in FIG. 1, WLAN 100 includes a first wireless device 110 and a second wireless device 150, which communicate via a wireless channel 145. Although described herein as “transmitter” and “receiver” for purposes of discussion, understand that both wireless devices may include transmitter circuitry and receiver circuitry such as implemented in one or more integrated circuits within each wireless device. For example, each wireless device may include one or more multi-protocol wireless transceivers that may be implemented as a standalone integrated circuit or included with additional processing capabilities, e.g., as a System-on-Chip (SoC).

For purposes of discussion, first wireless device 110 is also referred to as a transmitter, as its transmit circuitry is shown. In the embodiment shown, first wireless device 110 includes a baseband processor 111. In the high level view shown in FIG. 1, various transmit functionality of baseband processor 111 is illustrated. As seen, wireless packets, e.g., Wi-Fi packets may be generated in a packet generator 112, in this embodiment. More generally, actual user data is passed down from upper layers of an OSI stack and formatted into one or more packets. In turn, separate fields of this packet, namely, signal and data fields, are provided to different portions of a signal processing path. As shown, the signal field is provided to an FEC encoder 114, which encodes the signal field with a selected type of forward error correction coding. Although embodiments are not limited in this regard, in one example this FEC encoding may be rate 1/2 convolutional code. The resulting FEC encoded signal field is provided to an interleaver 116 to perform interleaving and provide the interleaved signal field to a modulator 118, which modulates the signal field.

As further shown in FIG. 1, a data field of the packet is provided to a scrambler 120, which scrambles the data field and provides it to another FEC encoder 122. Encoder 122 encodes the data field according to the same FEC encoding scheme. The encoded data field is punctured in a puncturer 124 and the resulting punctured data field is interleaved in an interleaver 126. The resulting interleaved data field is modulated in a modulator 128.

Still referring to FIG. 1, these modulated fields are provided to a sub-carrier mapping circuit 130, which maps the modulated fields onto sub-carriers. In turn, pilot signals are inserted within the sub-carriers in a pilot insertion circuit 132. The resulting sub-carriers (S(f)) of the packet are provided to an inverse fast Fourier transform (IFFT) circuit 134, which converts the frequency signal into the time domain. A cyclic prefix of the resulting time domain signal is calculated in a cyclic prefix circuit 136. Finally, a preamble is inserted into the time domain signal in a preamble insertion circuit 138, resulting in a transmitted signal 155.

As shown, transmitted signal 155 is provided to a radio frequency (RF) front end circuit 140, which operates to convert the baseband time domain signal to an RF level and perform various equalizations, filtering and gain control to output an amplified RF signal.

This RF signal is transmitted via a wireless channel 145, and is received in an RF front end circuit 160 of second wireless device 150. RF front end circuit 160 may perform amplification, filtering, downconversion and so forth, to pass a baseband received signal to a baseband processor 161. As shown, received signals are provided to a packet detector 162, which performs packet detection and provides the detected packet to a synchronizer 164 and also to a correlator 165. In an embodiment, correlator 165 may be implemented as an LTS correlator, the output of which is provided also to synchronizer 164. The synchronized signal is provided to a carrier frequency offset (CFO) correction circuit 166, which performs CFO correction and provides the resulting time domain signal to a fast Fourier transform (FFT) circuit 168, which converts the time domain signal to the frequency domain as a plurality of sub-carriers of the received signal (R(f)), representing the signal transmitted from first wireless device 110, with channel impairments.

The resulting sub-carriers are provided to various components, including a distance estimation circuit 170, a phase error estimator 172, an equalizer 174 and a channel estimator 175. Although in the embodiment of FIG. 1, distance estimation circuit 170 is illustrated as a separate block, in one or more other implementations, distance estimation circuit 170 can be implemented using other (e.g., general purpose) processing circuitry that executes a distance estimation algorithm or application. Error estimator 172 estimates a phase error, which it provides to equalizer 174. Equalizer 174 also receives a channel estimate from channel estimator 175. In this way, equalizer 174 corrects the received sub-carriers to provide a frequency domain signal field and a frequency domain data field to, respectively, demodulators 178, 183. The signals are processed in their respective paths via corresponding de-interleavers 180, 184 and the deinterleaved signal output from de-interleaver 180 is decoded in a decoder 182, which provides rate information to demodulator 183. The de-interleaved signal output from de-interleaver 184 is de-punctured in a depuncturer 185 and decoded in a decoder 186. The resulting decoded signal is de-scrambled in a descrambler 187. A cyclic redundancy checksum (CRC) check is performed in a CRC check circuit 188. When a valid CRC has been detected, a resulting data packet can be provided to further downstream processing (not shown for ease of illustration in FIG. 1). Note also that a feedback signal from CRC check circuit 188 is provided to distance estimation circuit 170. Although shown with this specific implementation in the embodiment of FIG. 1, understand that more generally circuit 188 can be implemented as an error detection circuit to detect an error in the received signal and provide this error detection feedback to distance estimation circuit 170.

Still referring to FIG. 1, the decoded signal output from decoder 186 is also provided to additional circuitry of an encoding path 191. These decoded symbols are used to create an approximation of the transmitted signal ‘S′(f)’ via encoding path 191. While encoding path 191 is shown as separate circuitry in the embodiment of FIG. 1, in other cases, such encoding operations may be performed in similar encoding circuitry of a transmitter of a second wireless device 150 (not shown for ease of illustration in FIG. 1). In these cases, existing transmitter circuitry of second wireless device 150 can be leveraged for performing the encoding.

As seen, encoder circuitry 191 includes an FEC encoder 190, which applies the same type of FEC encoding as applied in first wireless device 110. The encoded signal is punctured in a puncturer 192. The resulting punctured signal is interleaved in an interleaver 194 and modulated in a modulator 195. In turn, sub-carrier mapping is performed in a sub-carrier mapping circuit 196. Finally, pilots may be inserted within the sub-carriers in a pilot insertion circuit 198. The resulting output, S′(f), is provided as an encoded signal to distance estimation circuit 170. This generated signal S′(f) is thus a representation of the actual signal transmitted from first wireless device 110 (without channel impairments).

In embodiments, distance estimation circuit 170 is configured to estimate the distance between first wireless device 110 and second wireless device 150 based on these processed signals (R(f) and S′(f)). Distance estimation circuit 170 operates to compare generated samples of S′(f) against samples of the received signal (R(f)) at the output of FFT circuit 168, to extract the channel frequency response ‘H′(f)’. Thereby, the measured amplitude and phase characteristics of the channel can be processed by a super resolution algorithm to sort out each signal path mathematically to precisely identify the shortest distance between the two devices. Although shown at this high level in the embodiment of FIG. 1, many variations and alternatives are possible.

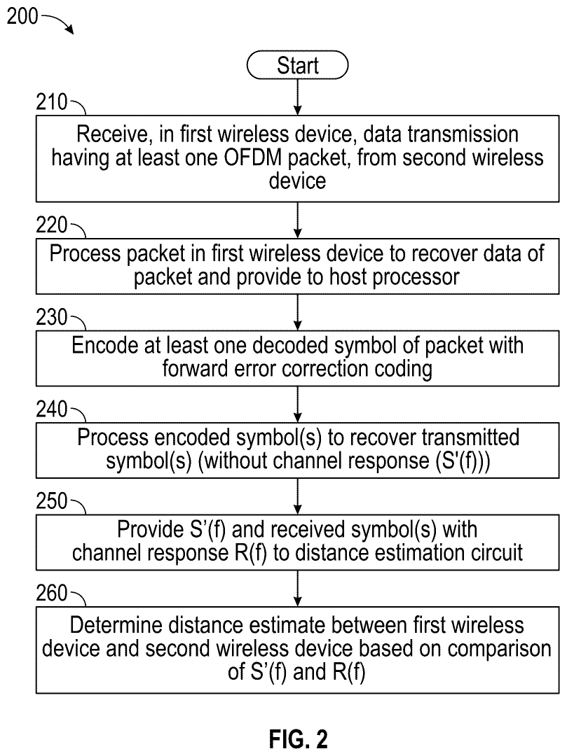

Referring now to FIG. 2, shown is a flow diagram of a method in accordance with an embodiment. As illustrated, method 200 is a method for performing distance estimation using error correction coding as described herein. As such, method 200 can be performed by hardware circuitry of a wireless device such as may be implemented in a wireless device capable of receiving RF signals according to a given type of wireless protocol. While for purposes of discussion herein a Wi-Fi protocol is described, embodiments are not so limited. Method 200 can be performed by this hardware circuitry alone and/or in combination with firmware and/or software.

As shown, method 200 begins by receiving a data transmission in the wireless device (block 210). This data transmission, which may be sent from another wireless device within a WLAN, includes at least one OFDM packet. Next at block 220, the packet can be processed in the wireless device to recover data of the packet and provide it to a host processor of the wireless device. That is, this data packet may include actual data that is being communicated between the devices, rather than a priori known information such as may be used for training or other purposes when a known signal is present. Stated another way, this received data transmission and the at least one OFDM packet include unknown data content (from the point of view of the receiver).

Still referring to FIG. 2, at block 230, in addition to providing the recovered data to a host processor, at least one decoded symbol of the packet can be encoded with forward error correction coding. As discussed above, the same type of FEC encoding applied on a transmitter side (e.g., using FEC encoder 122 of FIG. 1) can be applied on the receiver side. Additional processing may be performed on these encoded one or more symbols to recover the transmitted symbol (S′(f)). Understand that this recovered transmitted symbol is the actual symbol that is transmitted, i.e., without a channel response.

Still referring to FIG. 2, the recovered transmitted symbol (S′(f)) and corresponding received symbol R(f), which includes the channel response, are provided to a distance estimation circuit (block 240). In one or more implementations, this distance estimation circuit may be implemented within circuitry of a baseband processor of the wireless device. Finally, at block 260, a distance estimate between the devices may be determined based on a comparison of these corresponding one or more symbols. With embodiments herein, this distance estimation may be of a relatively high accuracy, e.g., with a distance error in centimeters, enabling its use in a variety of contexts. Although shown at this high level in the embodiment of FIG. 2, many variations and alternatives are possible.

As described above, depending upon implementation, distance estimation may be performed based on information from one or more symbols of a given packet. In still further cases, one or more symbols of multiple frames may be analyzed in determining a distance estimate. Although embodiments are not limited in this regard, the number of symbols and/or packets on which a distance estimation may be determined can be based on various factors, including conditions of a wireless channel between the devices, the content of data, and so forth.

For example, distance estimation can be performed on a selected “N” number of symbols. In embodiments, the value of “N” may depend on the randomness of the transmitted data and/or Signal-to-Noise Ratio (SNR) of the communication channel. If the transmitted data is truly random and channel noise is low, the channel frequency response can be estimated using a single OFDM symbol. On the other hand, if the transmitted data is biased to contain more ‘0’s or ‘1’s, then multiple OFDM symbols can be used to measure the channel frequency response. Likewise, depending on the SNR of the communication, the distance estimation algorithm can perform multiple measurements of the channel frequency response to improve the overall accuracy of the solution. Therefore, the value of “N” can be treated as a dynamic variable in the implementation.

CRC information as to whether the CRC check passed or failed for a particular packet can serve as a confidence metric when using the corresponding measured channel frequency response. Based at least in part on this information, when operating in a noisy environment, e.g., as determined based on the number of CRC errors, information from multiple OFDM frames can be aggregated to improve the accuracy of the estimated distance. Alternatively, when the communication sees a lot of CRC errors, the receiver can request the transmitting device to operate at a lower data rate to improve the reliability of the communication, as well as the estimated distance.

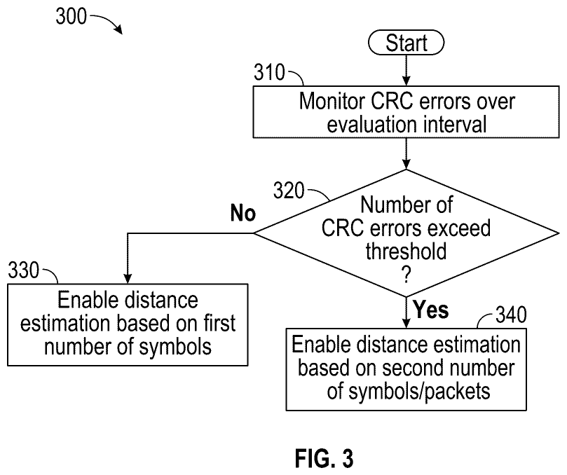

Referring now to FIG. 3, shown is a flow diagram of a method in accordance with another embodiment. As shown in FIG. 3, method 300 is a method for controlling operation of distance estimation as described herein. As such, method 300 can be performed by similar hardware circuitry and/or firmware and/or software of a wireless device such as discussed above in FIGS. 1 and 2.

As illustrated, method 300 begins by monitoring CRC errors over an evaluation interval (block 310). As described above, a receiver can determine, on a packet basis, whether a CRC error is identified. These CRC errors may be indicated via a feedback signal from the CRC check circuit to the distance estimation circuit. In different implementations, the length of the evaluation interval may vary.

Still referring to FIG. 3, next at diamond 320, it is determined whether the number of CRC errors exceeds a given threshold. If not, this means that the wireless channel is relatively strong. Accordingly, control passes to block 330 where distance estimation may be enabled to occur based on a first number of symbols. This number of symbols could be one or more, and may be such one or more symbols of a single packet, given the strong signal conditions. Otherwise when it is determined that the number of CRC errors over the evaluation interval exceeds the threshold, control passes to block 340. At block 340, distance estimation may be enabled to occur based on a second number of symbols. This second number of symbols has more symbols than the first number of symbols, and can be symbols of multiple packets. Although shown at this high level in the embodiment of FIG. 3, many variations and alternatives are possible.

Embodiments can be used with a variety of Wi-Fi data rate options when operating under additive white Gaussian noise (AWGN) and fading channels. Examples include MCS0 (BPSK ½) and additional MCS indices 1,2,3 etc. (QPSK ½, QPSK ¾, 16 QAM ½ etc.) as defined in the IEEE 802.11 standard. In addition to operation using convolutional codes along with a hard-decision decoder, embodiments can also be extended to support other FEC techniques such as, but not limited to, Hamming code, Reed Solomon code and Low-Density Parity Check (LDPC) codes, as well as supporting a soft-decision decoder.

Embodiments can analyze channel response at selected frequency intervals and channel bandwidths, such as may be available in various Wi-Fi protocols, including Wi-Fi 4, Wi-Fi 5, Wi-Fi 6, and Wi-Fi 7. For example, channel response can be measured across 20 MHz, 40 MHz, 80 MHz, 160 MHz and/or 320 MHz, respectively.

In embodiments, channel response can be measured across a plurality of overlapping channels within a frequency range. For example, 5 overlapping 20 MHz channels covering the frequency range from 2.402 GHz to 2.482 GHz can be analyzed. The measured amplitude and phase response of these channels is processed using a super resolution algorithm in a distance estimation circuit to estimate distance between wireless devices.

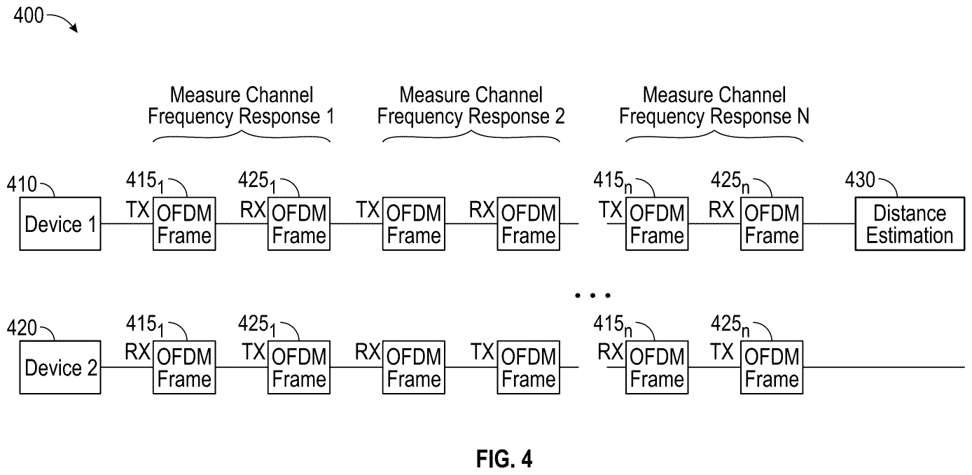

Referring now to FIG. 4, shown is a timing diagram illustrating a wireless ranging process in accordance with an embodiment. As shown in FIG. 4, timing diagram 400 illustrates wireless communications between a pair of wireless devices 410, 420. As shown, first wireless device 410 transmits a first plurality of OFDM frames 415_{1-N} and receives a second plurality of OFDM frames 425_{1-N}, transmitted by second wireless device 420.

As further shown, first wireless device 410 performs a distance estimation as described herein. More specifically as shown, first device 410 measures a channel frequency response for each of second frames 425. Then after N channel responses are measured, first wireless device 410 performs a distance estimation 430, as described herein. In this arrangement, averaging is performed to improve the accuracy of the distance estimation, especially when operating in low SNR conditions. Averaging values of 1, 2, 4, 8, 16 and 32 can be used in different implementations.

The impact of a wireless channel on a transmitted signal can be modeled as bit-flips in a received encoded sequence, such that modified bits can be equiprobable to be either a 0 or 1. The channel's impact can therefore be visualized as moving the encoded sequence closer to some codewords and simultaneously away from others. While the number of bits modified in the received sequence and their corresponding values are unknown to a receiver, as long as the modified bits are far apart compared with the constraint length of the code, an error can be independently analyzed and addressed by the receiver. This is especially true when using an OFDM PHY, since the use of interleaving ensures that coded sequences are arranged in a random order to minimize the effects of burst error in the communication. As a result, effectiveness of embodiments can be analyzed as a function of the Bit Error Rate (BER) of the decoded sequence as a function of the communication's Signal-to-Noise Ratio (SNR).

In various use cases, embodiments enable distance estimation to be performed when only a single one of two communicating devices is configured to perform channel frequency-based distance estimations as described herein. In this way, an existing device base can benefit from the distance estimation techniques described herein, even when they do not themselves include support for the techniques, via distance estimation circuitry and/or firmware and/or software as described above. Furthermore, existing devices in the field can be updated with firmware and/or software to enable such devices to perform distance estimation techniques, even when a communicating partner does not provide for this capability.

Also, understand that in various use cases, the channel frequency response-based distance estimation techniques can be performed based on one-way communications from a remote link partner. Stated another way, there is no need for round trip or two-way communications between a receiving device that performs the distance estimation and a remote link partner communicating conventional data packets that the receiving device uses for distance estimation.

As a result, channel frequency response-based distance estimation can be enabled for a wide range of installed devices, such as by updating only certain wireless devices, e.g., access points, routers, gateways or so forth. When such updates occur (or these devices are natively provided with the described distance estimation capabilities), conventional wireless devices not having distance estimation circuitry, firmware and/or software can send conventional data transmissions to a receiving device. In turn the receiving device can determine a distance estimate as described herein. The resulting distance estimate then may be communicated back to the link partner device. The link partner in turn may use that information to perform various control operations such as controlling transmit power (e.g., reducing transmit power when the devices are close together, and increasing transmit power when the devices are further away).

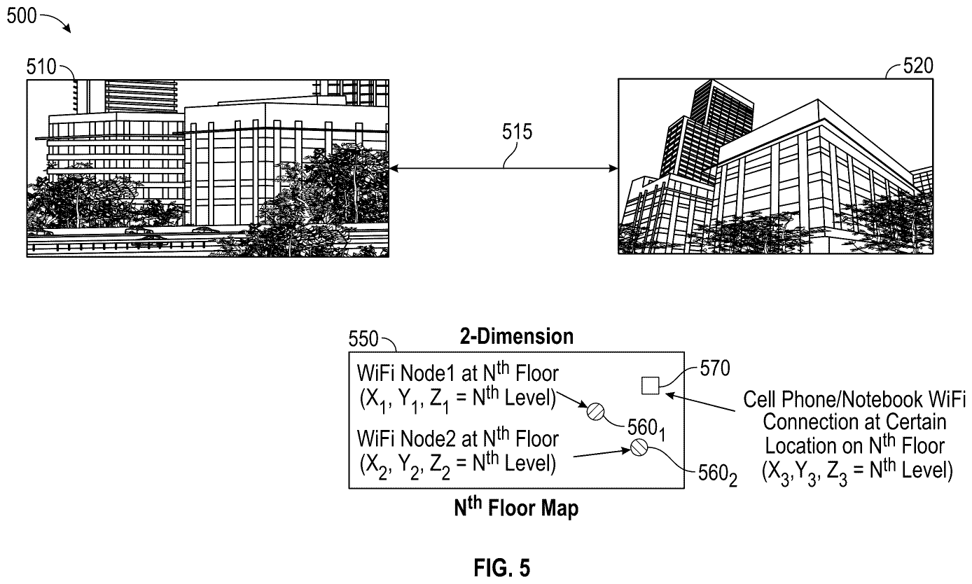

Referring now to FIG. 5, shown is a block diagram of a network environment in accordance with an embodiment. As shown in FIG. 5, network environment 500 is in the context of multiple buildings 510, 520, which may be office buildings of a given corporation or so forth that share a common computing network, illustrated as intra-building network 515. With this arrangement and known location of at least certain wireless devices, such as one or more Wi-Fi nodes present on given floors of buildings 510, 520 a channel frequency-based distance estimation can be performed as described herein.

As one example use case, a user in, say, building 510 can identify a location of another user, e.g., a work colleague, based on a location of that colleague's smartphone or other wireless device with respect to a Wi-Fi node in building 520. Thus as further shown in FIG. 5, a floor map 550 stored in the computing network identifies a location (e.g., with X, Y, Z coordinates) of various Wi-Fi nodes (e.g., access points, routers or so forth), namely Wi-Fi nodes 560₁, 560₂ on a given floor.

Assume that wireless nodes 560 are configured to perform channel frequency response-based distance estimations as described herein. With known information regarding a location of a given wireless node 560, and a distance estimate performed by wireless node 560, a location of a user device 570 of a user can be determined. Wireless node 560 may send this distance estimate determined using the techniques described herein to a user in remote building 510 to determine the location of the user of wireless device 570.

Note that this ranging use case can further be extended by further obtaining additional positioning information, e.g., leveraging location information of multiple cellular towers in proximity to building 550. For example, a “Find My Location” feature such as available on a given smartphone can be used to obtain coarse location information. Then via the known location of a given Wi-Fi node 560, fine location information based on a distance estimate using Wi-Fi node 560 can be determined.

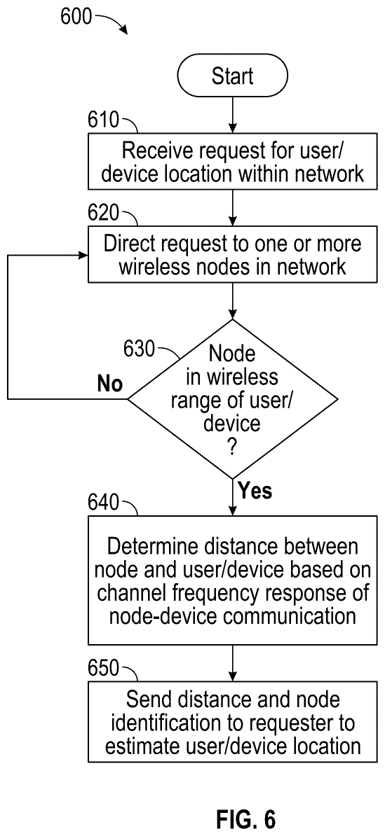

Referring now to FIG. 6, shown is a flow diagram of a method in accordance with another embodiment. As shown in FIG. 6, method 600 is a method for locating a user device within a network having fixed known locations of at least certain Wi-Fi nodes. As such, method 600 can be performed by hardware circuitry of one or more devices, at least one of which can perform distance estimations as described herein. As shown, method 600 begins by receiving a request for a user/device location within a network (block 610). For example, a user located in one building of a corporation or other entity may seek to determine location of another employee in a remote location of the entity.

This request may be received in a device of the requester, which directs it to one or more wireless nodes (e.g., access points or routers) within the entity's network (block 620). Such nodes, at diamond 630, determine whether any such node is within a wireless range of the requested user/device. If so, at block 640, a distance between the wireless node and the user/device may be determined based on a channel frequency response of communications between the node and the device. Note that these communications may be a one-way communication from the device to the node, e.g., a ping message or so forth. Also, understand that this device of the remotely located user need not have the capability itself for performing the distance estimation techniques described herein.

Still referring to FIG. 6, once the distance is determined, the access point may send a message to the requester, e.g., including distance information, namely, the distance between the access point and the user/device and an identification of the node itself. From this information, the requesting device can determine the user/device location (block 650).

Note that in other implementations, the wireless node determining the distance estimate can itself provide the location information directly, rather than requiring the requesting device to perform this calculation. Understand while shown at this high level in the embodiment of FIG. 6, many variations and alternatives are possible.

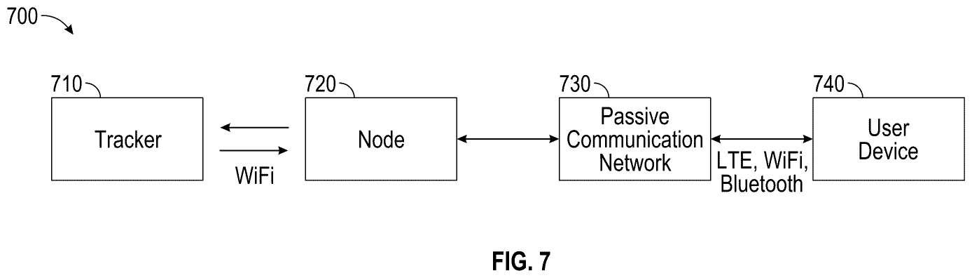

Referring now to FIG. 7, shown is a block diagram of a network environment in accordance with another embodiment. In FIG. 7, network environment 700 may be a very wide area network in which devices can communicate, in part, using a passive network 730, e.g., of a service provider and/or device manufacturer, such as an Apple or Google passive communication network, which includes servers and/or other datacenter equipment to process and store information regarding users' smartphones and other such devices.

In network 700, assume presence of a wireless tracker 710, e.g., a small, low power IoT device such as a disk, button or so forth, that can be used as a tracking device. A user may place tracking device 710 within an item that the user wants to track, such as a piece of luggage, a set of keys, within a car or so forth. Various tracker devices 710 may provide for wireless communication, e.g., wireless pings that may be received by any Wi-Fi nodes 720 in proximity to device 710.

Understand that a given node 720 may perform a channel frequency-based distance estimation as described herein to estimate distance between itself and tracker device 710. In turn, this location information can be communicated, e.g., via passive communication network 730, to an end user device 740, e.g., of the user who placed tracker device 710. In this way, the distance ranging techniques described herein can be used in any Wi-Fi reachable area, even when a user is potentially vastly remotely located from tracker device 710 (e.g., even on a different continent).

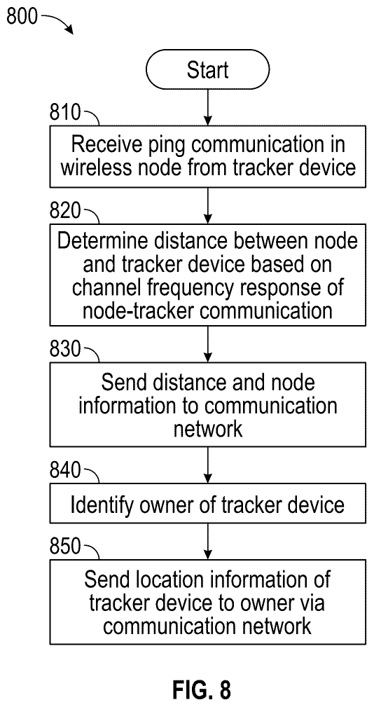

Referring now to FIG. 8, shown is a flow diagram of a method in accordance with yet another embodiment. More specifically, method 800 is a method for tracking location using the channel frequency response-based distance estimation techniques described herein. As such, method 600 can be performed by hardware circuitry of one or more devices, at least one of which can perform distance estimations as described herein.

As shown, method 800 begins by receiving a ping communication in a wireless node from a tracker device (block 810). From this ping communication, the node can perform a channel frequency response-based distance determination based on this node-tracker communication (block 820). In turn, the node sends the distance estimate and node information to, e.g., a passive communication network (e.g., of a smartphone provider) (block 830). Next the communication network may identify an owner of the tracker device, e.g., using an identifier of the tracker device included within the ping communication and the resulting message from the node to the communication network (block 840). Finally, at block 850, location information of this tracker device can be sent via this communication network to the owner, e.g., via a smartphone of the user. Although shown at this high level in the embodiment of FIG. 8, many variations and alternatives are possible.

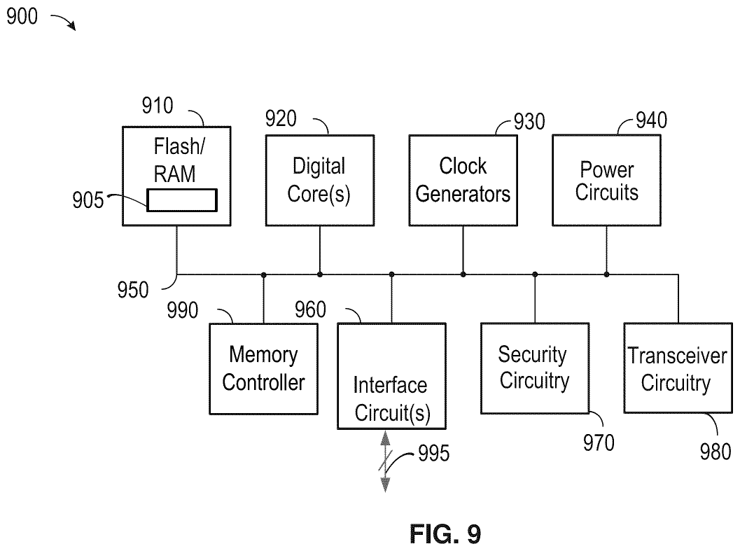

Referring now to FIG. 9, shown is a block diagram of a representative integrated circuit 900 that includes support for performing distance estimation techniques as described herein. In the embodiment shown in FIG. 9, integrated circuit 900 may be, e.g., a multi-mode wireless transceiver that may operate according to one or more wireless protocols (e.g., Wi-Fi and Bluetooth, and/or one or more other protocols) or other device that can be used in a variety of use cases. In one or more embodiments, the circuitry of integrated circuit 900 shown in FIG. 9 may be implemented on a single semiconductor die or implemented on separate dies for wireless communication, MCU compute, external flash and/or other IP blocks.

Integrated circuit 900 may be included in a range of devices, but for purposes of discussion, it may be incorporated into a wireless node such as an access point, gateway, or router. In the embodiment shown, integrated circuit 900 includes a memory system 910 which in an embodiment may include volatile storage, such as RAM and non-volatile memory such as a flash memory. The flash memory is a non-transitory storage medium that can store instructions and data. In embodiments, this storage may store code 905 for performing channel frequency response-based distance estimations, as described herein. Integrated circuit 900 also may include a memory controller 990.

Memory system 910 couples via a bus 950 to one or more digital cores 920, which may include one or more cores and/or microcontrollers that act as processing units of the integrated circuit, and which may execute code 905 to determine a distance to a communicating partner, e.g., based on normal data communications with the communicating partner, as described herein. In turn, digital cores 920 may couple to clock generators 930 which may provide one or more phase locked loops or other clock generator circuitry to generate various clocks for use by circuitry of the IC.

As further illustrated, IC 900 further includes power circuitry 940. Additional circuitry may be present depending on particular implementation to provide various functionality and interaction with external devices. Such circuitry may include interface circuitry 960 which provides a digital communication interface with additional circuitry (to IC 900 via a link 995). IC 900 also may include security circuitry 970 to perform wireless security techniques.

In addition, as shown in FIG. 9, transceiver circuitry 980 may be provided to enable transmission and reception of wireless signals, e.g., according to one or more of a local area or wide area wireless communication scheme, such as Bluetooth, IEEE 802.11, IEEE 802.15.4, cellular communication or so forth. Understand while shown with this high level view, many variations and alternatives are possible.

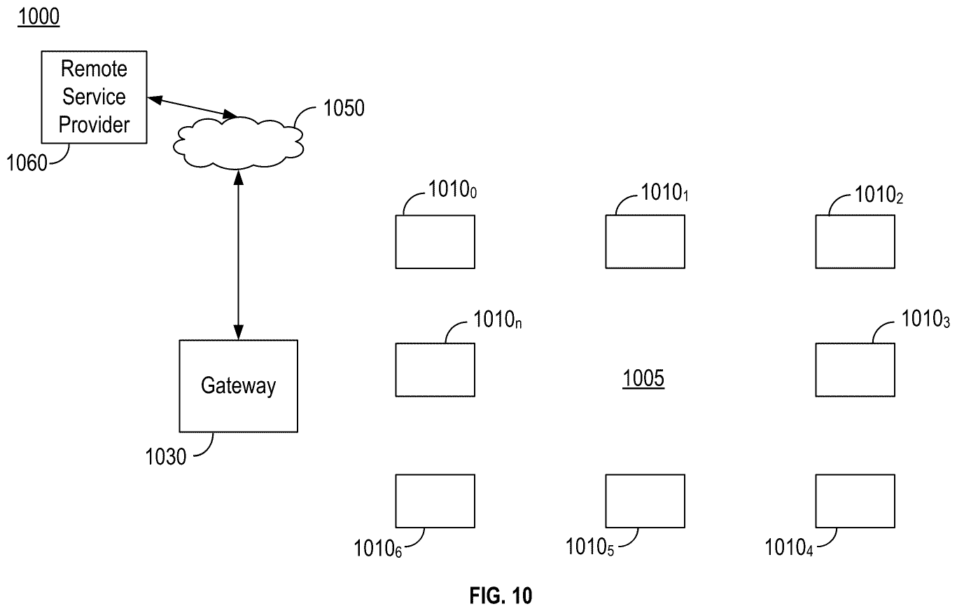

ICs such as described herein may be implemented in a variety of different devices as described above. Referring now to FIG. 10, shown is a high level diagram of a network in accordance with an embodiment. As shown in FIG. 10, a network 1000 includes a variety of devices, including access points, one or more of which may be configured to perform channel frequency response-based distance estimations as described herein, gateways and remote service providers.

In the embodiment of FIG. 10, a wireless network 1005 is present, e.g., in a building having multiple wireless nodes 10100-n. As shown, wireless nodes 1010 may be access points that couple to a gateway 1030 that in turn communicates with a remote service provider 1060 via a wide area network 1050, e.g., the Internet. Understand while shown at this high level in the embodiment of FIG. 10, many variations and alternatives are possible.

Embodiments thus provide a channel frequency response-based distance measurement technique for Wi-Fi, leveraging error correction capabilities of the PHY, along with a super-resolution algorithm to achieve sub-meter level ranging accuracy. By using both amplitude and phase characteristics of a wireless channel to estimate distance, embodiments are more resilient against multipath. As a result, embodiments provide better distance resolution, multipath handling and measurement stability compared with RSSI and ToF-based distance measurement techniques. As described herein, embodiments may scale to different channel bandwidths, carrier frequencies, and error correction techniques, and implementations can select these parameters in part based on capabilities of a given wireless device.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving, in a first wireless device, a data transmission from a second wireless device, the data transmission comprising at least one orthogonal frequency division multiplexing (OFDM) packet;
processing, in the first wireless device, the at least one OFDM packet to recover data and provide the data to a host processor of the first wireless device;
encoding, in the first wireless device, at least one decoded symbol of the at least one OFDM packet with forward error correction (FEC) coding;
processing the encoded at least one decoded symbol to recover at least one corresponding transmitted symbol (S′(f)) of the at least one OFDM packet; and
determining a distance estimate between the first wireless device and the second wireless device based at least in part on the corresponding transmitted symbol (S′(f)).

2. The method of claim 1, wherein processing the at least one OFDM packet to recover the data comprises transforming the at least one OFDM packet comprising a time domain signal into a plurality of recovered symbols (R(f)), each of the plurality of recovered symbols (R(f)) comprising a plurality of sub-carriers, the plurality of recovered symbols (R(f)) comprising a channel response.

3. The method of claim 2, wherein determining the distance estimate comprises:
comparing corresponding symbols of S′(f) and R(f); and
determining the distance estimate based at least in part on the comparing.

4. The method of claim 3, further comprising:
determining at least one metric of a channel between the first wireless device and the second wireless device; and
determining a number of the corresponding symbols of S′(f) and R(f) to compare based at least in part on the at least one metric.

5. The method of claim 3, further comprising:
receiving feedback information regarding an error detection operation on the at least one OFDM packet; and
based at least in part on the feedback information, determining a number of the corresponding symbols of S′(f) and R(f) to compare.

6. The method of claim 1, further comprising determining the distance estimate using amplitude and phase information of a channel between the first wireless device and the second wireless device.

7. The method of claim 1, further comprising determining the distance estimate using the at least one OFDM packet, the at least one OFDM packet not including a priori information.

8. The method of claim 1, further comprising encoding, in a transmitter of the first wireless device, the at least one decoded symbol of the at least one OFDM packet with the FEC coding.

9. The method of claim 1, further comprising:
after determining the distance estimate between the first wireless device and the second wireless device, communicating distance information to the second wireless device based at least in part on the distance estimate, to enable the second wireless device to control transmit power using the distance information, the second wireless device unconfigured to determine the distance estimate.

10. The method of claim 1, further comprising:
receiving, in the first wireless device, the data transmission comprising a plurality of OFDM packets;
determining a channel frequency response of a channel between the first wireless device and the second wireless using at least some symbols of the plurality of OFDM packets; and
determining the distance estimate between the first wireless device and the second wireless device based on the channel frequency response.

11. An apparatus comprising:
a radio frequency (RF) front end circuit to receive and process an incoming Wi-Fi RF signal, and to output a baseband signal; and
a baseband processor coupled to the RF front end circuit, the baseband processor comprising:
a receiver signal processing path to receive the baseband signal and process the baseband signal to obtain a data packet therefrom;
first circuitry to use the data packet to measure a channel frequency response of a channel between the apparatus and a second device that transmitted the incoming Wi-Fi RF signal based on a one-way communication of the incoming Wi-Fi RF signal from the second device to the apparatus, the channel frequency response comprising amplitude and phase information of the channel; and
second circuitry to determine a distance between the apparatus and the second device based at least in part on the channel frequency response.

12. The apparatus of claim 11, further comprising encoder circuitry to receive at least one decoded symbol of the data packet, encode the at least one decoded symbol, and generate, based on the encoded at least one decoded symbol, a representation of at least one transmitted symbol included in the incoming Wi-Fi RF signal, the at least one transmitted symbol corresponding to the at least one decoded symbol.

13. The apparatus of claim 12, wherein the first circuitry is to measure the channel frequency response based at least in part on the representation of the at least one transmitted symbol and at least one received symbol of the at least one data packet corresponding to the representation of the at least one transmitted symbol.

14. The apparatus of claim 11, wherein the apparatus comprises a multi-protocol transceiver comprising a receiver and a transmitter, the transmitter comprising the encoder circuitry.

15. The apparatus of claim 11, further comprising an integrity detection circuit to determine an integrity of the at least one data packet and provide feedback information based on the integrity to the second circuitry.

16. The apparatus of claim 15, wherein the second circuitry is to determine a number of the at least one data packet to use to measure the channel response based at least in part on the feedback information.

17. The apparatus of claim 11, wherein the second circuitry is to determine an average of a plurality of channel responses, each of the plurality of channel responses associated with a data packet, and determine the distance based at least in part on the average.

18. A system comprising:
a transceiver to transmit and receive radio frequency (RF) signals of at least one wireless protocol; and
a baseband processor coupled to the transceiver, the baseband processor comprising:
a receiver signal processing path to receive a baseband signal of the at least one wireless protocol and process the baseband signal to obtain a data packet therefrom;
an encoder coupled to the receiver signal processing path, the encoder to receive at least one decoded symbol of the data packet, encode the at least one decoded symbol, and generate, based on the encoded at least one decoded symbol, a representation of at least one transmitted symbol corresponding to the at least one decoded symbol; and
a distance estimation circuit to estimate a distance between the system and a second system based at least in part on the representation of the at least one transmitted symbol and at least one received symbol of the data packet corresponding to the representation of the at least one transmitted symbol.

19. The system of claim 18, wherein the distance estimation circuit is to measure a channel frequency response of a channel between the system and the second system based on a comparison of the representation of the at least one transmitted symbol to the at least one received symbol of the data packet corresponding to the representation of the at least one transmitted symbol.

20. The system of claim 19, wherein the distance estimation circuit is to estimate the distance based on the channel frequency response.
